(19) United States
(12) Patent Application Publication
(10) Pub. No.: US 2012/0052255 A1
(43) Pub. Date: Mar. 1, 2012

(54) PLASTIC RECYCLING METHOD AND MANUFACTURED PRODUCT

(75) Inventors: Alex Abadi, Austin, TX (US); Michael Terry McMullen, JR., Cedar Park, TX (US); Dan Michael Adams, Georgetown, TX (US); Robert Gallagher, Georgetown, TX (US)

(73) Assignee: IMAGE MICROSYSTEM, INC., Austin (TX)

(21) Appl. No.: 13/109,545

(22) Filed: May 17, 2011

Related U.S. Application Data
(60) Provisional application No. 61/345,269, filed on May 17, 2010.

(51) Int. Cl. B32B 3/10; B32B 27/00; C08J 11/04; B22F 9/04

(52) U.S. Cl. 428/195.1; 264/140; 521/40

(57) ABSTRACT

A method of recycling plastic e-waste material and products made from recycled e-waste involves one or more separate streams of different plastic waste which are reduced to small granular form, blended together or separately or used separately before insertion into a compounder which reduces the small sized plastic particles to a semi-molten emulsion. The emulsion is placed in a press and molded to a final product shape. The final product is finished and inspected. The products from the recycled plastic e-waste can be used as substrates on road signs.

### CROSS REFERENCE TO CO-PENDING APPLICATION

This application claims priority benefit to the May 17, 2010 filing date of pending U.S. Provisional Patent Application Ser. No. 61/345269, the entire contents which are incorporated herein by reference.

### BACKGROUND

In recent years, environmental concerns about the amount of electronic waste (e-waste) plastic being dumped in landfills have met with rising interest. The proliferation of computers, cellular telephones and other electronic devices using plastic components has proliferated.

Many plastic products have been recycled, although on a smaller than desirable small scale. One of the difficulties in recycling e-waste plastic materials is that the large quantities of the same types of plastic materials are difficult to obtain. Further, the recycling collection process generally lumps all plastic parts or products together thereby preventing easy separation of the different types of plastics.

Another recycling trend that has been initially taken place in Europe is the requirement for the manufacturers of certain e-waste plastic parts, particular computer and cellular telephone parts, to take back the product at the end of its useful life for recycling.

In view of the trend toward increased plastic recycling and the difficulties currently involved in successfully recycling e-waste plastics at high volumes, it is desirable to provide a method of recycling e-waste plastic and manufacturing products from such recycled plastic.

### SUMMARY

A method of recycling products made from e-waste thermoplastic material into new products and products made by such a method are disclosed.

In one aspect, the method of recycling products made from e-waste thermoplastic material includes the steps of:

breaking down plastic parts into smaller particulates;

converting the plastic particulates into semi-molten mass; and

molding the semi-molten mass to form a new product.

The step of breaking down the e-waste plastic parts into particulates may include the steps of cutting the plastic parts into smaller pieces, and using at least one of a tumbling operation and a grinding operation to reduce the small pieces into smaller particulates.

During the grinding operation, the temperature of the small sized plastic parts are maintained below the melting point of the plastic parts by the injection of cold air during the grinding process.

In one aspect, a first stream of plastic parts formed of computer and printer parts formed substantially of ABS plastic is provided. A second, separate material stream is employed for printer ink cartridges to reduce the ink cartridges into small particulates and to separate the foam ink insert from the plastic particulates.

According to one aspect, the materials from the first and second material streams are stored in separate silos. Selected quantities range between 0 and 100% of each of the first and second material streams are transferred to a blender which weighs the material and forms a blended mass in the selected percentage of the first and second material particulates.

The blended mass is then transferred to a compounder which reduces the particulates of the blended mass into a semi-molten state.

According to one aspect, the semi-molten mass from the compounder is transferred in a carrier which is surrounded with a ventilation apparatus to remove emissions and particulates from the semi-molten mass. The semi-molten mass is then transferred to a mold to form an end product.

In another aspect, a product is made according to the above-described method. The product may, for example, be employed as a base or substrate for a road sign or any other signage. Decorative indicia is applied to one surface of the substrate in the form of a decorative film or printed directly on the surface of the substrate to complete the sign. The substrate may also be molded to its final shape without decorative indicia for other applications, such as landscape, stepping stones, etc.

### DETAILED DESCRIPTION OF THE DRAWING

The various features, advantages and other uses of the present e-waste plastic recycling method and manufactured product will become more apparent by referring to the following detailed description and drawing in which:

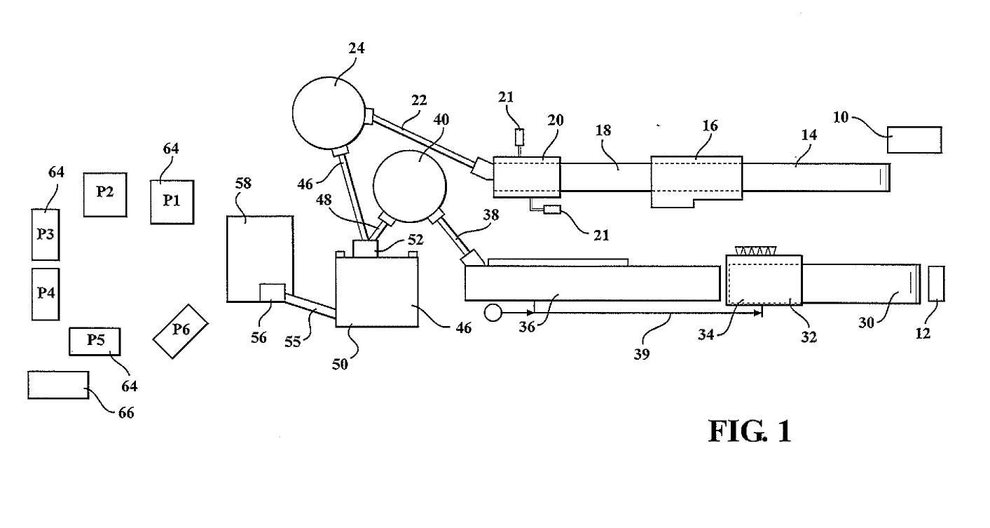

FIG. 1 is a schematic diagram of an e-waste plastic recycling method equipment layout;

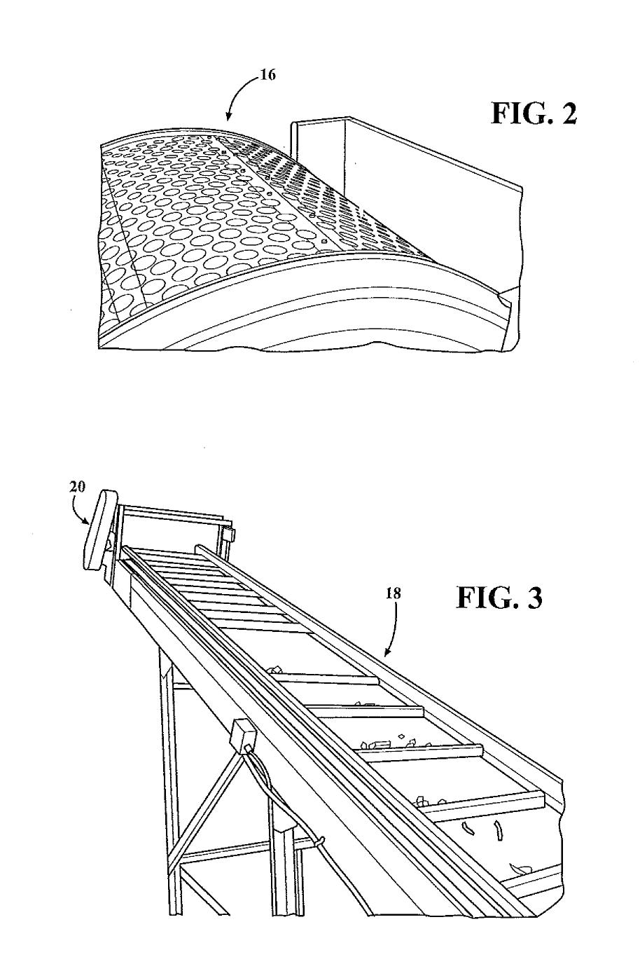

FIG. 2 is a partial perspective view of the tumbler shown in FIG. 1;

FIG. 3 is a perspective view of the conveyor used to convey broken down plastic from the tumbler to the grinder shown in FIG. 1;

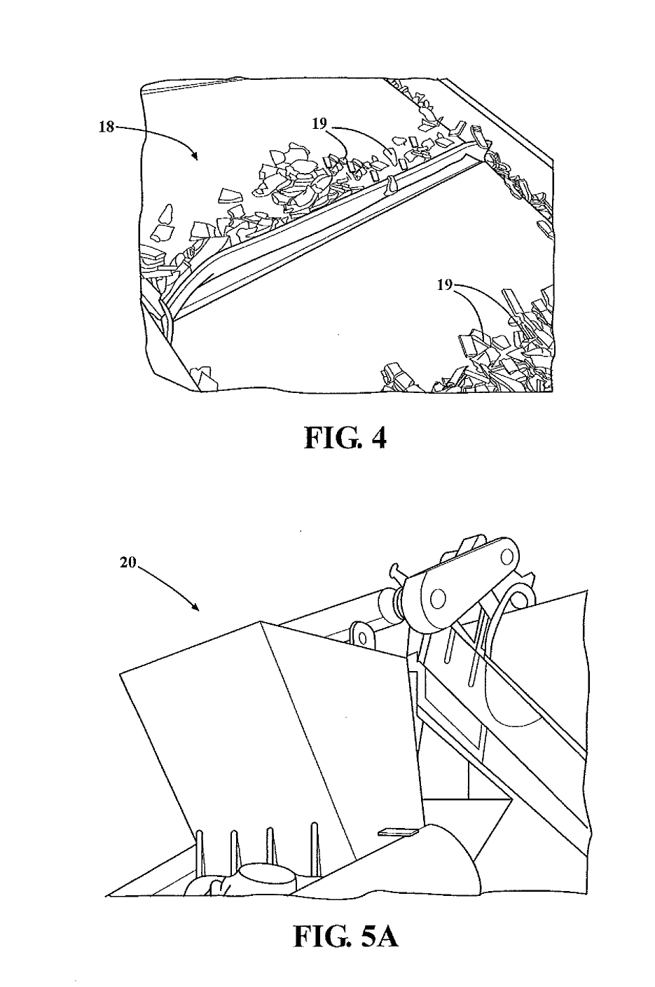

FIG. 4 is an enlarged perspective view of the plastic particles on the conveyor shown in FIG. 3 after exiting the tumbler;

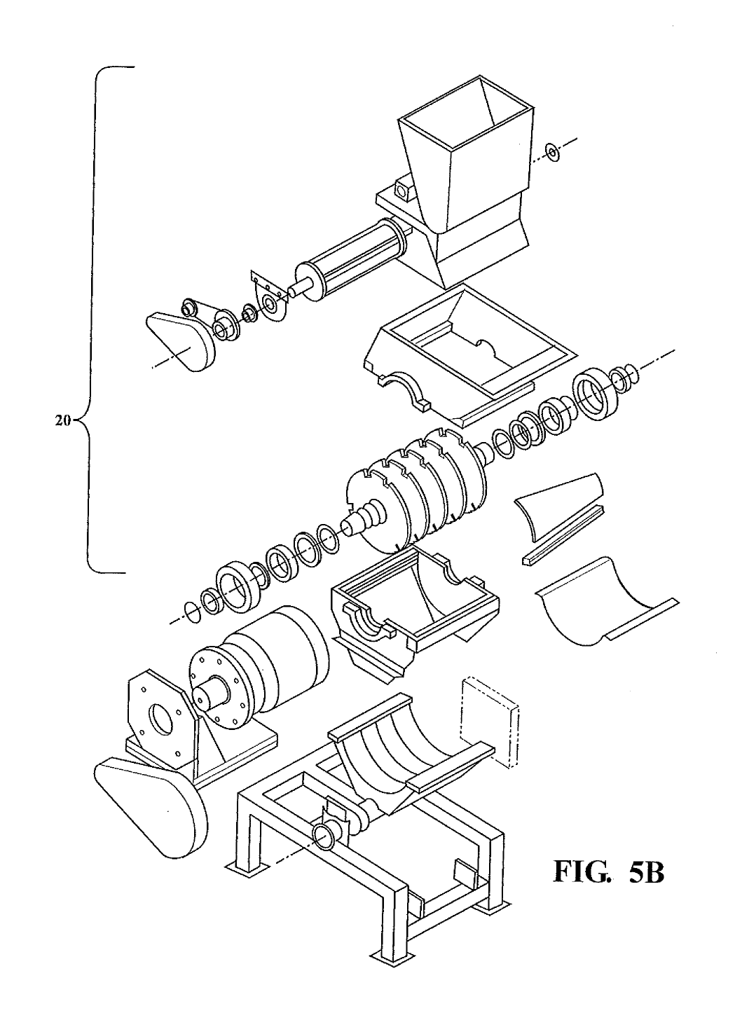

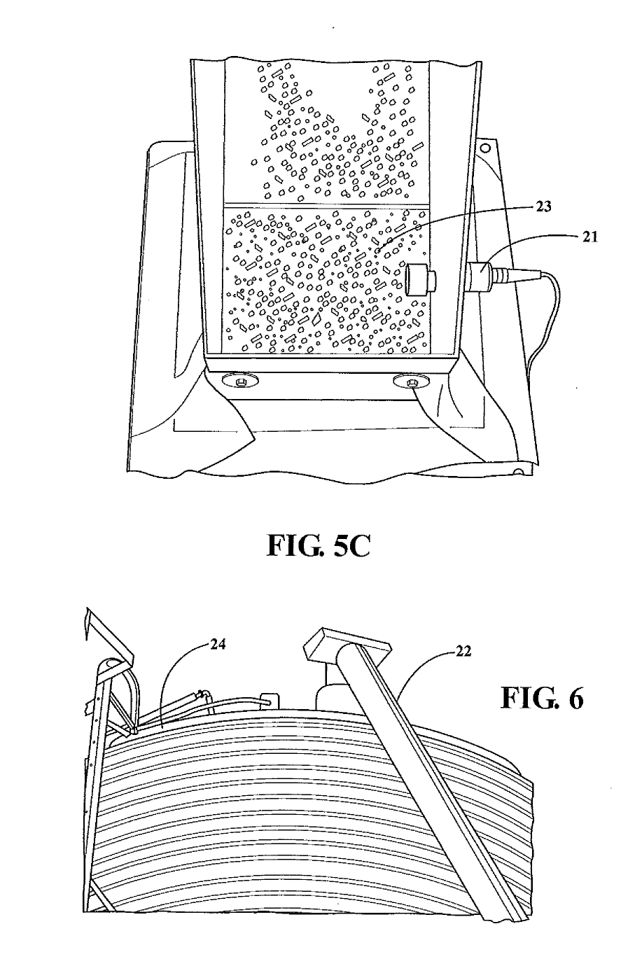

FIG. 5A is a partial perspective view of the grinder shown in FIG. 4.

FIG. 5B is an exploded, perspective view of the components forming the grinder;

FIG. 5C is a perspective view of the small plastic particles exiting the grinder;

FIG. 6 is a perspective view of a custom auger used to carry the plastic particles from the discharge area of the grinder to a storage silo;

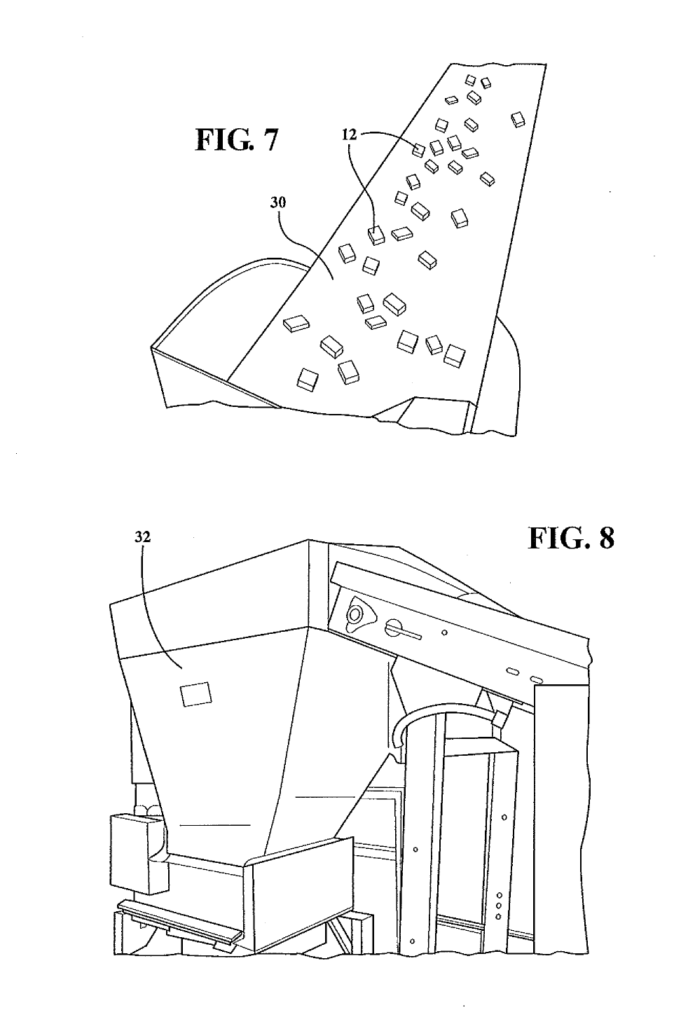

FIG. 7 is a perspective view of a conveyor used to transport bulk printer ink cartridges to the cracker/grinder shown in FIG. 1;

FIG. 8 is a perspective view of the custom cracker/grinder shown in FIG. 1;

FIG. 9 is an enlarged plan view of the knives in the cracker/grinder;

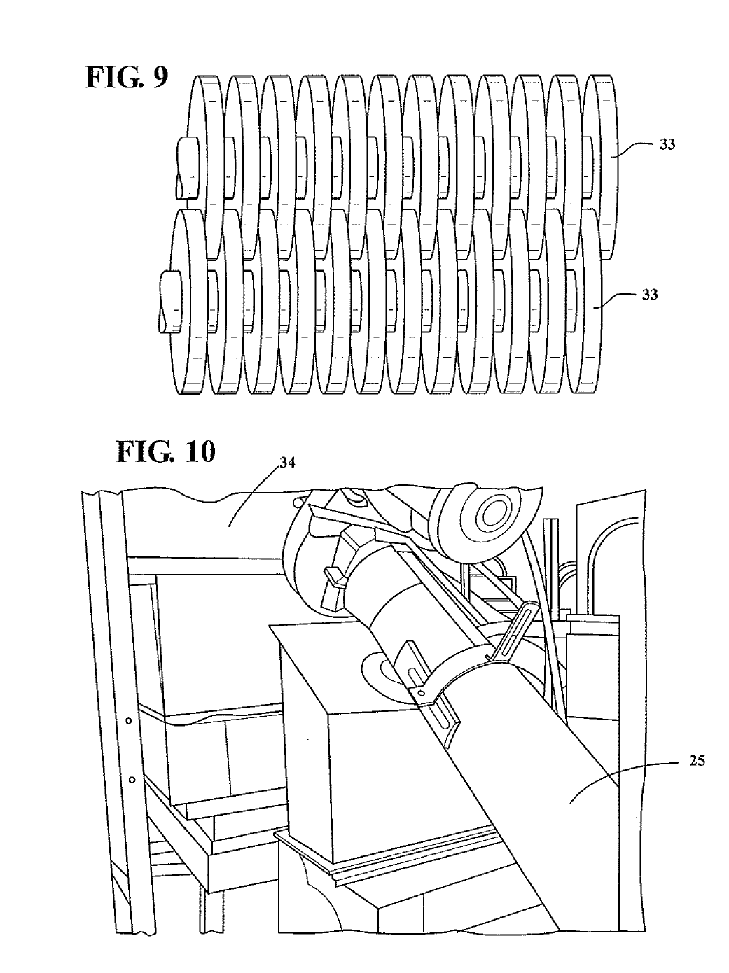

FIG. 10 is a perspective view of the conveyor/auger used to transport the plastic particles from the cracker to the chipper shown in FIG. 1;

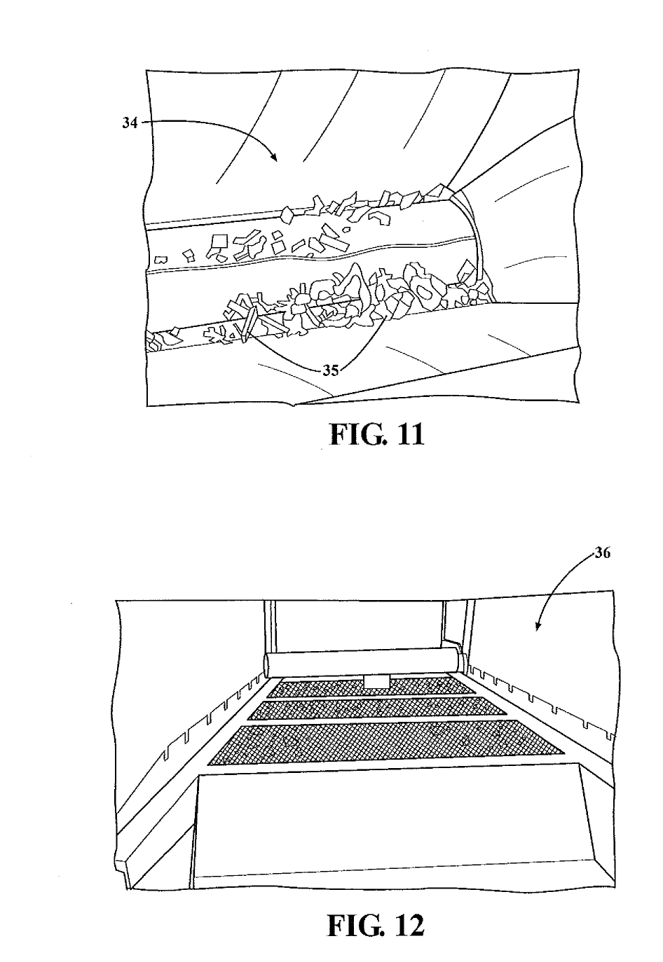

FIG. 11 is a perspective view of the interior of the chipper showing the reduction of the plastic material into granules;

FIG. 12 is a perspective view of the interior of the shaker table shown in FIG. 1

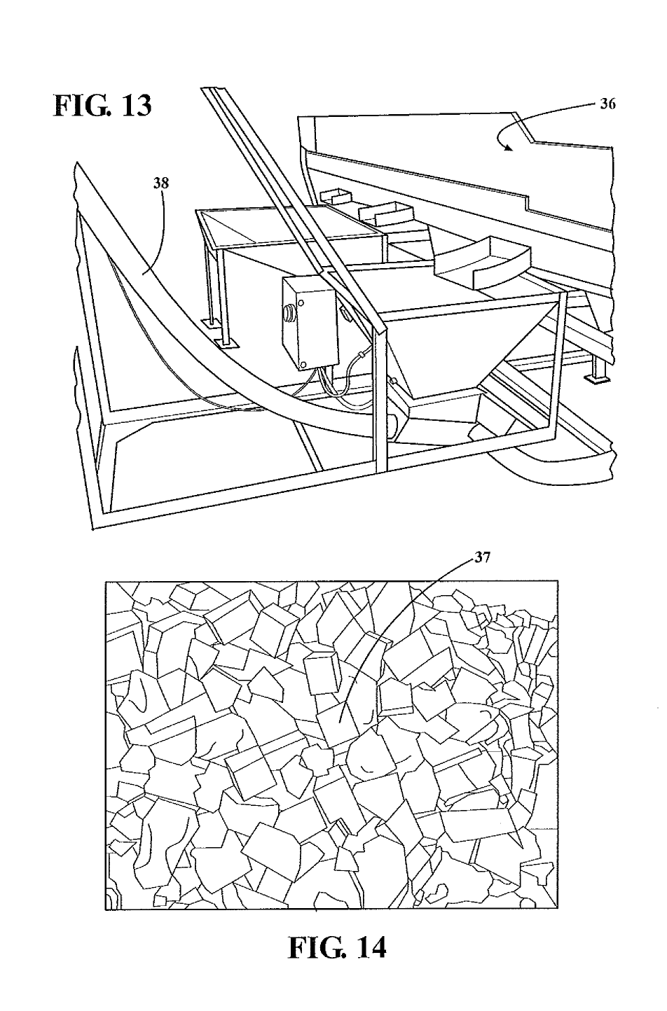

FIG. 13 is a perspective view of the conveyor used to transport the plastic pieces from the shaker table to a storage silo;

FIG. 14 is a plan view of the foam pieces after separation from the plastic pieces on the shaker table;

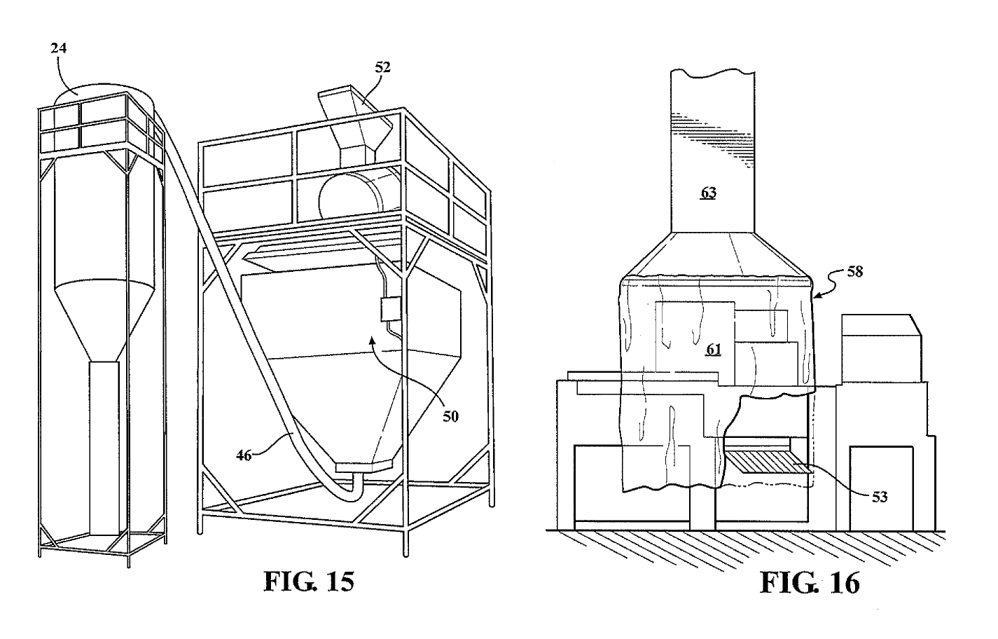

FIG. 15 is a perspective view of the custom mixing unit or blender shown in FIG. 1;

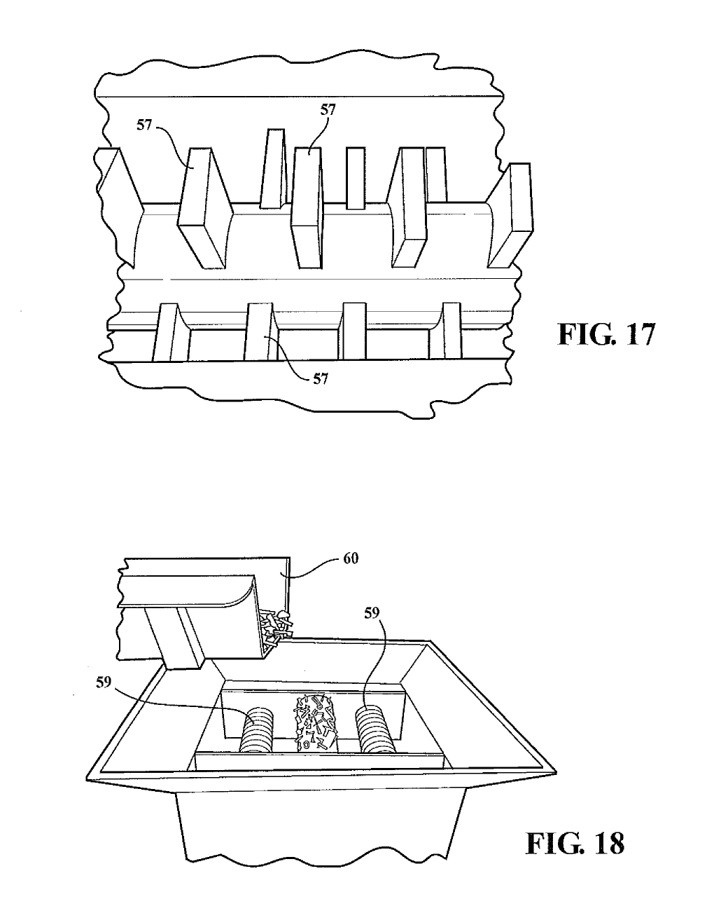

FIG. 16 is a side elevational view of the compounder and ventilation apparatus shown in FIG. 1;

FIG. 17 is a partial perspective view of the compounder teeth;

FIG. 18 is a perspective view of the plastic particulates input to the compounder.

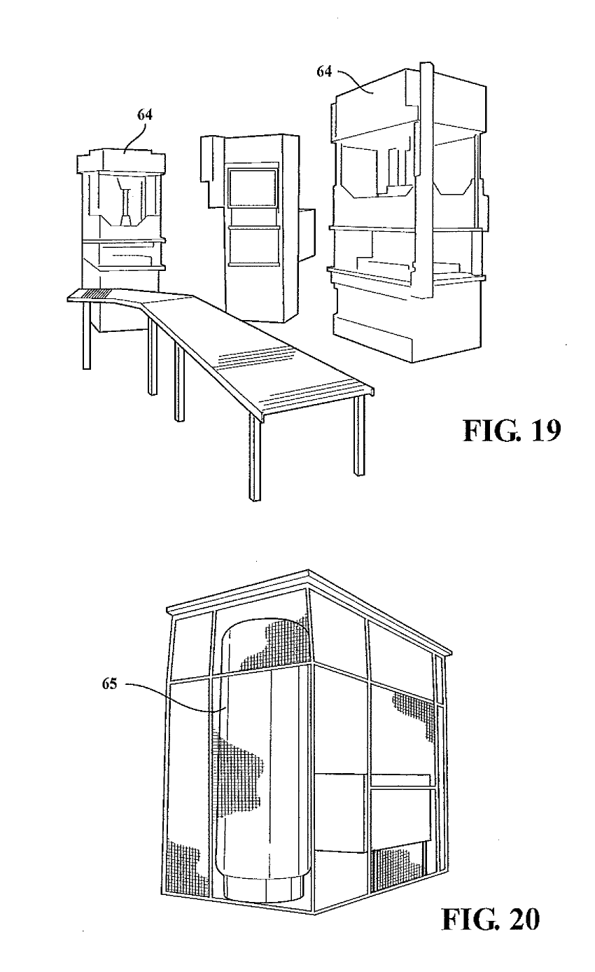

FIG. 19 is a perspective view of the multiple molding presses shown in FIG. 1;

FIG. 20 is a perspective view of the chiller used with the presses shown in FIG. 19;

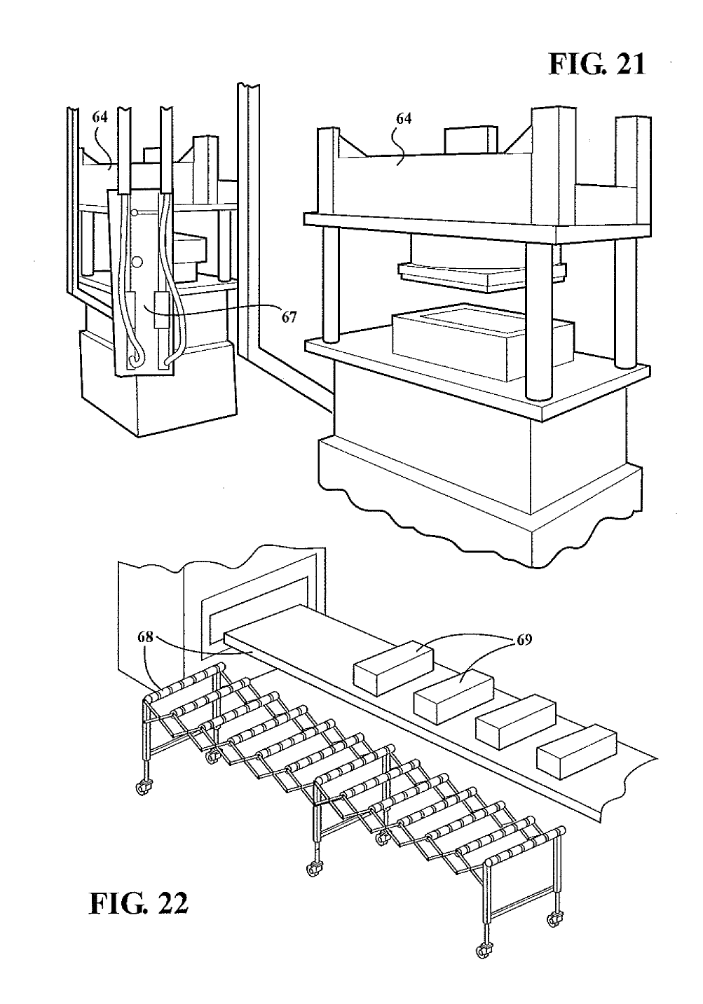

FIG. 21 is a perspective view of the heating and cooling control system 67 employed with the presses shown in FIG. 9;

FIG. 22 is a perspective view of the finished product on weighting tables after molding;

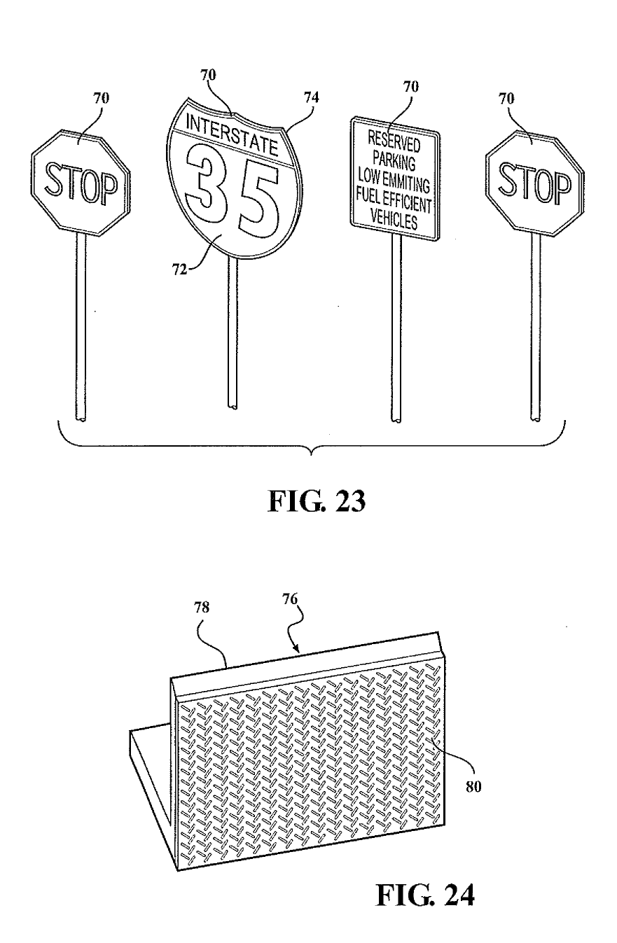

FIG. 23 is a front elevational view of road signs which can be made using the recycled e-waste plastic recycling method described herein;

FIG. 24 is a perspective view of a road delineator (barrier reflector) which can be made using the e-waste plastic recycling method; and

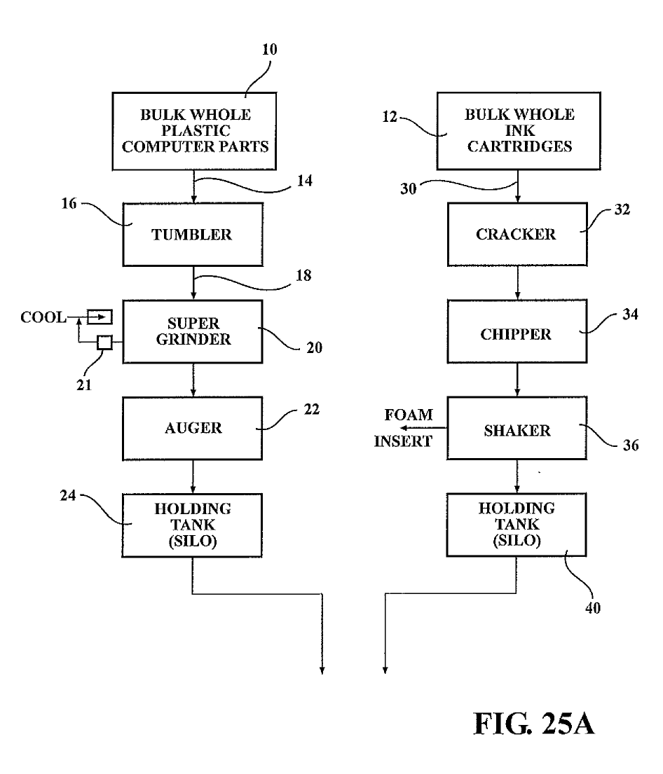

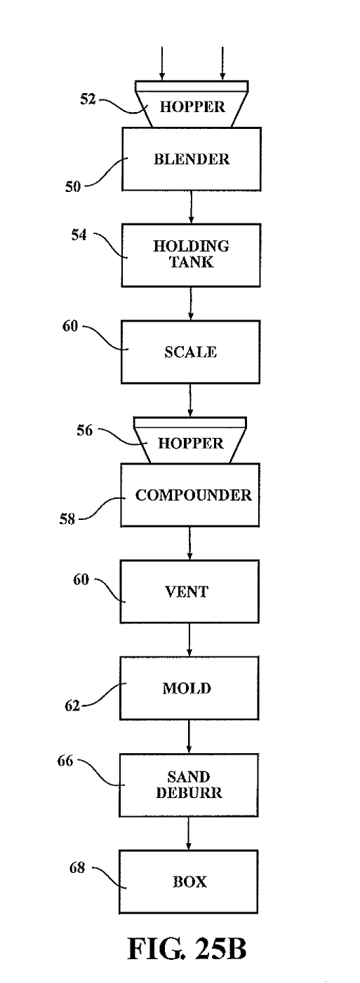

FIGS. 25A and 25B are flow diagrams depicting the sequential steps on the e-waste plastic recycling method.

### DETAILED DESCRIPTION

The following is a description of an e-waste plastic recycling method and a product manufactured by the recycling method. The recycling method is particularly designed for manufacturing products made from recycled e-waste plastic, such as e-waste plastic from hard plastic computer parts and inkjet cartridges.

The following recycling method and resulting manufactured products will be described as being made from ABS plastic which is typically used to form rigid computer parts, such as computer and printer housings, and spent ink cartridges. It will be understood that the inventive method may also employ other types of rigid plastic, such as various thermoplastic materials including polycarbonate, polystyrene, SAN (styrene-acrylonitrile), and polyvinylchloride (PVC). Suitable thermoplastics may also be crystalline, namely, acetal, nylon, polyethylene, polypropylene and polyesters, or liquid cyrstalline plastics. Other suitable thermoplastics may include polyvinylchloride (PVC), acrylics, fluoropolymers and polymides. Mixtures and copolymers of these materials may also be used in practicing the inventive method.

Computers and inkjet cartridges arrive at the manufacturing site and are dissembled and sorted into bulk e-waste plastic 10 and ink cartridges 12 as shown in FIG. 1 and FIG. 25A. The pieces of e-waste plastic 10 arriving at the bulk plastic staging area are cut or broken down to pieces no larger than 12 inches by 18 inches.

In a first plastic material recycling stream, the computer, printer, or other rigid e-waste plastic parts 10 are conveyed by a modified conveyor 14 to a tumbler 16, which, by example only, can be a model no. 136AZ-45 tumbler manufactured by Shred Pax, Inc., Wood Dale, Ill. The tumbler 16, shown in greater detail in FIG. 2, includes two rotating cylinders carrying teeth which break down the rigid e-waste plastic 10 into small pieces 19 shown in FIG. 4 After tumbling in the tumbler 16, the material is reduced in size to between ¼″×1″and 1″×2″.

The material is then conveyed by conveyor 18; see FIGS. 3 and 4, to a custom designed super grinder 20 which can be, for example, a Shred Pax, Inc. model no. 136AZ-7V grinder. The super grinder 20, shown in detail in FIGS. 5A and 5B, has been modified to a more robust construction using steel teeth and screws instead of aluminum teeth and screws, grinds the small pieces of plastic into granular form 23 shown in FIG. 5C leveraging specific temperatures of forced air. The grinder 20 is cooled by two Exair cold gun systems 21; see FIGS. 1 and 25B, which maintain a constant flow of air generated from a compressor to create a vortex. The air is filtered through a self contained air filtration system and supplied to the grinder 20 to maintain the temperature of the ground plastic below a predetermined temperature level to prevent significant melting of the plastic into a flowable state which has a tendency to stick to and clog the teeth of the grinder 20. After exiting the grinder 20, the material is between 1/16″× 1/16″ and ⅜″×⅜″ in size as seen in FIG. 5C.

From the grinder 20, the granular plastic is transferred by an enclosed, custom fabricated auger 22, shown in detail in FIG. 6, to a silo or hopper 24 for storage. The auger 22 is completely enclosed substantially along its entire length to prevent the escape of particulates as the granular plastic moves along the auger 22.

In a separate, parallel, second plastic material recycling stream, the bulk printer ink cartridges 12 are placed on a conveyor 30, shown in FIGS. 1 and 7, and transported to a cracker 32, FIG. 8, which contains an enclosed, rotating series of specifically sized knives 33 shown in FIG. 9. The cracker 32 breaks open the plastic shell of the ink cartridges 12 to expose the polyurethane foam insert in the ink cartridges 12.

Via a customized, enclosed auger 25, FIG. 10, the plastic is transferred from the cracker 32 to a custom enclosed rotating, double edged, bladed chipper/grinder 34 also shown in FIG. 10, which grinds the plastic material into granular form 35 as seen in FIG. 11. For example, the chipper 34 is modified to have 10 mill teeth size, a variable speed motor, and a safety lid. The auger 25 is designed to prevent emissions to the ambient environment from the granular pieces

The granular pieces are then transferred from the chipper/grinder 34 to a modified shaker table 36, shown in FIG. 12. The shaker table 36 separates the foam 37, shown in FIG. 14, from the plastic. As the shaker table 36 vibrates, the plastic pieces fall through a grate and are routed to a storage silo 40 by a custom enclosed auger 38 shown in FIG. 13.

As shown in FIG. 1, at least one regrind conveyor 39 is provided along the shaker table 36 and extends from an outlet or discharge port on the shaker table 46 back to the grinder 34. This enables larger pieces of the second stream plastic parts to be returned to the grinder 34 and reground into smaller pieces. One or two regrind conveyors 39 may be provided on opposite sides of the shaker table 36, by example.

The foam pieces 37, shown in FIG. 14, bounce to the end of the shaker table 36 and fall directly from the shaker table 36 into a container, such as a lined Gaylord box, and sent off-site for further processing into alternative energy products.

The ground plastic material in the silos or hoppers 24 and 40 can be transferred either manually or by an automated program via enclosed augers 46 and 48 to a blender or mixer machine 50 as shown in FIG. 15. The blender machine 50 has a unique capability to run multiple mixing programs. The mixing programs determine the percentage of e-waste plastic 10 from the hopper 24 and the ink cartridge plastic 12 from the hopper 40 in the final mixture. By way of example only, the e-waste plastic in the hopper 24 in the first plastic recycling stream is referred to as “clean plastic” since it contains of substantially all ABS plastic from computer shrouds and printer parts. On the other hand, the inkjet cartridge plastic waste in the hopper 40 from the second recycling stream is referred to as “dirty plastic” since it contains printer cartridge pieces, little bits of dried ink, small circuit board chips, and small amounts of metal and foam particles.

The percentage of either of the first and second plastic streams may range from 0% to 100% and will be chosen in accordance with the property requirements of the end product. By way of example only, when the end product is a landscaping stepping stone, the material from the hoppers 24 and 40 is selected in a 75% clean plastic/25% dirty plastic ratio, by way of example only. It will be understood that other ratios may also be employed, depending upon the use requirements of the end product, the availability of computer and printer housings and ink jet printer cartridges, as well as for material flexibility and end product consistency.

The blender 50 also enables color to be provided in the end product. This can be achieved by mixing separate amounts of colorant in the blender 50. Alternately, by way of example only, a selected color of the end product can be obtained by forming the plastic particulates in one or both of the hoppers 24 and 40 of the selected color plastic, such as green, blue etc.

According to the selected control program in the blender 50, varying amounts of either or both of the two plastic material types 10 and 12 are drawn from the respective silos 24 and 40 and carried up to a hopper 52 above the blender 50 through custom engineered augers 46 and 48, as shown in FIG. 15. The hopper 52 sits directly above the blender or mixer 50.

The blender 50 is a custom fabricated WSB series weigh scale blender made by L-R Systems of Joliet, Ill. The blender 50 is designed to mix the two components according to one of 99 recipes loaded into a memory. Materials are individually metered by auger feeders 46 and 48 into the batch mixing drum of the blender 50 until a recipe base set point is reached. The material drops from the hopper 52 into the mixing chamber of the blender 50 where the materials are then blended together.

In a process where only one of the first and second plastic streams is used, the blender 50 may or may not be employed. Since only one plastic stream is employed, the blender is not required to provide the function of blending plastic particles from two different plastic streams. However, the blender 50 may still be employed in this situation for its preset batch quantity selection capability.

After a batch is completed, a mixing timer, which can be set between 0 and 60 seconds, starts timing. After the conclusion of the set mixing time period, the timer opens the slide gate to dump the mixing barrel into a collection bin or enclosed holding tank 54 of the blender 50. The slide gate then closes enabling the blender 50 to start the next batch based on any material recipe.

When the materials are needed, the materials are transferred by an enclosed auger 55 to a hopper 56 which is located directly over a custom engineered compounder 58 shown in FIGS. 1 and 16.

Prior to compounding, the material drawn from the holding tank 54 is weighed on an inline scale 60, FIG. 18. After the material is weighed, it is injected into the compounder 58 as shown in FIGS. 16, 17 and 18 wherein it undergoes emulsification. The compounder 58 is a custom modified compounder using thermo-kinetic technology manufactured by Resyk, Inc., now owned by Integrico. During emulsification, magnets 59. FIG. 18, in the compounder 58 remove any large metal pieces prior to the actual compounding or emulsification by teeth 57.

After emulsification, a carrier or tray 53 holding the emulsified plastic material descends below the compounder 58 behind a curtain 61 and vent hood 63 shown in FIG. 16. The vent hood 63 has an acrylic curtain 61 with three inch overlapping sheets that surround the compounder 58 and the compounder output tray 53. The plastic curtain 61 reaches substantially to the floor.

Above the curtain 61 is a two foot draw fan ducted up to a second three foot draw fan located in the ceiling of the manufacturing facility. Exhaust exits the duct stack at 4,500 cubic feet per minute.

The operator waits for a few seconds to remove the material from the compounder output tray to maximize the emissions captured by the vent hood 63. The curtain 61 and vent hood trap 63 approximately 100 percent of the particulates and VOC emissions during heating of the plastic material during the compounding process. A small percent of the total emissions may be released into the compounder room during the transfer of the material from the compounder output tray.

After waiting the prescribed few seconds, the operator reaches through the curtain 61 and removes the output tray containing the emulsified recycled e-waste material.

The material is then manually transferred to a mold 62 in one of a plurality of presses 64. The presses 64 can be hydraulic presses, for example. The presses 64 are cooled by a 15 ton customized Zarsky chiller 65, model no ACWC-180-E, for example, which keeps the mold cool during the molding process to set the final plastic product. The chiller 65 is housed separately from the presses 64 as shown in FIG. 20.

For certain types of molds, a combination of heating and cooling is required. The control of the timing and the exact combination of heating and cooling is executed by a control system 67 connected to the chiller and each press 64 as shown in FIG. 21.

After the plastic product has been set in the final shape, the product is released from the mode and placed on waiting tables 68, as shown in FIG. 22, before entering a sanding machine 66 for deburring. A final quality inspection is performed after deburring.

After passing inspection, the final product 69 is placed in a distribution staging area to be palletized and shrink wrapped for shipment to the customer.

The product made from the recycled e-waste plastic according to the present process can take a number of different shapes. For example, as shown in FIG. 23, the recycled plastic material can be molded into a substrate or base 74 for creating road signs 70 or any other type of signage. A suitable film 72, such as 3M reflective sheeting tape, carrying decorative indicia adhered to one side of the recycled e-waste plastic substrate 74 to create the road signs shown 70 in FIG. 23. A road delineator 76 or barrier reflector to delineate the edges of roads on curves, etc. is another product which can be made by the plastic recycling method described above. The delineator 76 includes a generally L-shaped substrate 78 formed of recycled plastic as described above. A thin layer of a reflective material 80 is secured to one surface of the delineator.

Alternately, the road sign indicia, or any other sign indicia for which the substrate is employed, can be printed, using available printing techniques, directly on one surface of the substrate 74. The applied coating may be reflective, partially reflective, or non-reflective, depending upon the purpose and use of the sign.

It is also possible to utilize the substrate 74, with or without indicia applied to one surface as the final end product. For example, the substrate 74 can be shaped and used as a landscaping stepping stone.

1. A method of recycling products made from e-waste thermoplastic material comprising the steps of:
breaking down e-waste plastic parts into small particulates;
converting the particulates into a semi-molten mass; and
molding the semi-molten mass to form a new product.

2. The method of claim 1 wherein the step of breaking down the e-waste plastic parts into small particulates further comprises the steps of:
cutting the plastic parts into smaller pieces; and
using at least one of a tumbling operation and a grinding operation to reduce the small pieces into the small particulates.

3. The method of claim 2 further comprising:
depositing the semi-molten mass into a carrier; and
surrounding the carrier with a ventilation apparatus to remove emissions and particulates from the semi-molten mass in the carrier.

4. The method of claim 2 wherein the step of breaking down the e-waste plastic parts to small particulates further comprises the steps of:
inserting the small pieces into a tumbler to reduce the small pieces to a smaller size; and
then grinding the smaller size pieces into the small particulates.

5. The method of claim 4 further comprising the step of:
maintaining a temperature of the small pieces during the grinding operation below a melting point of the small pieces.

6. (canceled)

7. (canceled)

8. The method of claim 1 further comprising the steps of:
breaking down spent plastic ink cartridges into small plastic particulates;
separating a foam ink insert from the small particulates;
converting the small particulates into a semi-molten mass; and
inserting the semi-molten mass into a mold to form a new product.

9. (canceled)

10. The method of claim 8 wherein the step of breaking down the plastic ink cartridges into small particulates further comprises the steps of:
subjecting the plastic ink cartridges to a cracking operation process to crack the plastic ink cartridges into small pieces and to separate the foam insert from the small pieces; and
subjecting the small pieces to a chipping operation to reduce the pieces to the small particulates.

11. The method of claim 10 further comprising:
conveying the small particulates of plastic ink cartridges between the cracking process and the chipping process by a substantially closed conveying apparatus.

12. (canceled)

13. (canceled)

14. A method for manufacturing a product from recycled e-waste plastic parts formed of thermoplastic material and plastic ink cartridges comprising the steps of:
in a first material stream:
breaking down plastic parts into small particulates;
depositing the small particulates into a first storage container;
in a second material stream separate from the first material stream:
breaking down plastic ink cartridges into small plastic particulates;
separating a foam insert from the small plastic particulates;
transferring the small plastic particulates to a second storage hopper;
blending predetermined quantities of the e-waste plastic particulates from the first material stream ranging between 0% and 100% of a total blended mass with predetermined quantities of the plastic particulates from the second material stream ranging between 100% and 0% of the total blended mass to form a blended mass;
converting the blended mass into a semi-molten mass; and
inserting the semi-molten mass into a mold to form a product.

15. The method of claim 14 further comprising:
depositing the semi-molten mass into a carrier; and
surrounding the carrier with a ventilation apparatus to remove emissions and particulates from the semi-molten mass in the carrier.

16. (canceled)

17. The method of claim 14 further comprising the steps of:
forming the first material stream of first plastic parts of substantially e-waste plastic material; and
forming the second material stream of second plastic parts of substantially like e-waste plastic material, wherein the second plastic parts are different from the first plastic parts.

18. The method of claim 17 wherein:
the step of forming the first material stream of the first plastic parts utilizes substantially all ABS material first plastic parts; and
the step of forming the second material stream of the second plastic parts utilizes substantially all ABS material second plastic parts.

19. (canceled)

20. The method of claim 14 further comprising the step of:
maintaining a temperature of the first plastic parts in the first material stream below a melting point of the plastic parts as the plastic parts are broken down into the small particulates.

21. (canceled)

22. (canceled)

23. (canceled)

24. (canceled)

25. A product comprising:
a body made of recycled e-waste plastic.

26. The product of claim 25 further comprising:
decorative indicia applied to one surface of the body.

27. The product of claim 26 wherein:
the body is formed substantially of recycled e-waste plastic from at least one of computer parts and printer ink cartridges.

28. The product of claim 26 wherein:
the body is substantially formed of recycled ABS plastic.

29. The product of claim 25 wherein:
the body is a molded body.

30. The product of claim 25 wherein:
the body forms one of a sign, a road sign and a road edge delineator.
